(19) United States
(12) Patent Application Publication
(10) Pub. No.: US 2026/0281840 A1
(43) Pub. Date: Sep. 17, 2026

(54) WIRELESS COMMUNICATION METHOD

(71) Applicant: PURPLEVINE INNOVATION COMPANY LIMITED, Hongkong (CN)

(72) Inventor: Chiu-Wen CHEN, Hongkong (CN)

(73) Assignee: PURPLEVINE INNOVATION COMPANY LIMITED, Hongkong (CN)

(21) Appl. No.: 19/471,372

(22) PCT Filed: Apr. 10, 2024
(86) PCT No.: PCT/CN2024/087081

§ 371 Date: Sep. 30, 2025

Related U.S. Application Data
(60) Provisional application No. 63/495,249, filed on Apr. 10, 2023.

(30) Foreign Application Priority Data
Sep. 28, 2023 (WO) PCT/CN2023/122898

(51) Int. Cl. H04W 36/00; H04W 36/08; H04W 36/26; H04W 52/02

(52) U.S. Cl. CPC H04W 36/0077; H04W 36/08; H04W 36/26; H04W 52/0206

(57) ABSTRACT

A wireless communication method for network energy saving. A user equipment (UE) receives a network energy saving (NES) barring information from a base station. The UE searches for and camps on a cell based on received network energy saving (NES) barring information. The NES barring information comprises at least one bit and indicates whether one or more user equipments (UEs) are permitted to camp on the NES cell. The NES barring information is used for cell selection/reselection based on UE capabilities.

### BACKGROUND OF DISCLOSURE

### 1. Field of Disclosure

The present disclosure relates to the field of communication systems, and more particularly, to a wireless communication method for a network energy saving (NES) system and related devices.

### 2. Description of Related Art

Modern cellular communication systems prioritize broadband and mobility. In Third Generation Partnership Project (3GPP) standards, User Equipment (UE) connects to the Radio Access Network (RAN) via a wireless link The RAN comprises base stations (BS) covering cells and providing wireless links to UEs Additionally, it interfaces with the Core Network (CN) for overall network control.

The 3GPP's Long-Term Evolution (LTE) system, namely Evolved Universal Mobile Telecommunication System Territorial Radio Access Network (E-UTRAN), utilizes eNodeBs (eNBs) supporting macro-cells. More recently, 5G or New Radio (NR) systems have emerged, with gNBs supporting various cell types. As 5G deployment expands across industries and regions, networks are becoming denser, employing more antennas, wider bandwidths, and diverse frequency bands to handle advanced services with very high data rates (e.g., Extended Reality, XR).

Network energy saving is crucial for environmental sustainability by reducing greenhouse gas emissions and lowering operational costs. With 5G's growing adoption, controlling its environmental impact is a priority, necessitating innovative solutions for improved network energy saving.

### Technical Problem

Energy consumption, a significant contributor to operator costs (OPEX), is a growing concern in cellular networks. Network power consumption can be divided into a dynamic power consumption (data transmission/reception) and a static power consumption (radio device operation).

The increasing number of connected devices significantly impacts network power consumption due to the need to maintain these connections. Hence, a wireless communication method is desirable to address this challenge and improve network energy efficiency by considering the diverse access capabilities of UEs.

### SUMMARY

An object of the present disclosure is to propose a wireless communication method

In a first aspect, an embodiment of the invention provides a wireless communication method for execution by a user equipment (UE), comprising:
receiving network energy saving (NES) barring information;
camping on a cell based on received NES barring information;
wherein the NES barring information comprises at least one bit and indicates whether one or more user equipments (UEs) are permitted to camp on an NES cell; and
the NES barring information is used for cell selection based on UE capability.

In a second aspect, an embodiment of the invention provides a user equipment (UE) comprising a processor configured to call and run a computer program stored in a memory, to cause a device in which the processor is installed to execute the disclosed method.

In a third aspect, an embodiment of the invention provides a wireless communication method for execution by a base station, comprising:
transmitting network energy saving (NES) barring information;
wherein the NES barring information comprises at least one bit and indicates whether one or more user equipments (UEs) are permitted to camp on an NES cell; and
the NES barring information is used for cell selection based on UE capability.

In a fourth aspect, an embodiment of the invention provides a base station comprising a processor configured to call and run a computer program stored in a memory, to cause a device in which the processor is installed to execute the disclosed method.

The disclosed method may be programmed as computer executable instructions stored in non-transitory computer readable medium. The non-transitory computer readable medium, when loaded to a computer, directs a processor of the computer to execute the disclosed method.

The non-transitory computer readable medium may comprise at least one from a group consisting of a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory.

The disclosed method may be programmed as a computer program product, that causes a computer to execute the disclosed method.

The disclosed method may be programmed as a computer program, that causes a computer to execute the disclosed method.

### Advantageous Effects

NES barring information is proposed in this disclosure. A NES-capable cell can enable the NES techniques and enter an NES state when the traffic load falls below a predetermined threshold. The UEs are configured with a NES configuration, which includes NES barring information. For different access capability of UEs, the corresponding UE behaviors for cell selection/reselection and communication is performed based on the associated NES configuration.

Embodiments of the disclosure provide advantages including:
1. Reduced Network and UE Power Consumption: At least one embodiment of the disclosed method enables significant power savings for both the network and User Equipment (UE) by leveraging Network Energy Saving (NES) techniques.
2. Enhanced Network Resource Efficiency: At least one embodiment of the disclosed method optimizes network resource allocation by employing NES procedures in the disclosed method, leading to improved efficiency
3. Increased UE-Network Connection Flexibility: At least one embodiment of the disclosed method provides greater flexibility in UE-to-network connections, potentially enabling more dynamic network configurations.
4. Minimal Impact on non-NES UEs: At least one embodiment of the disclosed method ensures minimal disruption to non-NES UEs by implementing targeted NES barring mechanisms.
5. Maintained Service Continuity During Mobility: At least one embodiment of the disclosed method allows for seamless service handover during UE mobility, ensuring service continuity for users.

### BRIEF DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field may obtain other figures according to these figures without paying the premise.

FIG. 1 illustrates a schematic view showing a telecommunication system.

FIG. 2 illustrates a schematic view showing a wireless communication system comprising a user equipment (UE), a base station, and a network entity.

FIG. 3 illustrates a schematic view showing protocol stacks used by UE and base station.

FIG. 4 illustrates a schematic view showing an example a radio access network (RAN) functional split architecture.

FIG. 5 illustrates a schematic view showing gNB state transitions in NR for Network Energy Saving (NES).

FIG. 6 illustrates a schematic view showing an example of UE behavior for communication in a NES-capable network.

FIG. 7 illustrates a schematic view showing another example of UE behavior for communication in a NES-capable network.

FIG. 8 illustrates a schematic view showing an embodiment of the disclosed method.

FIG. 9 illustrates a schematic view showing a first embodiment of the disclosed method.

FIG. 10 illustrates a schematic view showing second and fifth embodiments of the disclosed method.

FIG. 11 illustrates a schematic view showing third, sixth, and nineth embodiments of the disclosed method.

FIG. 12 illustrates a schematic view showing a seventh embodiment of the disclosed method.

FIG. 13 illustrates a schematic view showing an eighth embodiment of the disclosed method.

FIG. 14 illustrates a schematic view showing a user equipment (UE).

FIG. 15 illustrates a schematic view showing a network node.

FIG. 16 illustrates a schematic view showing a chip or executing the disclosed method in a UE.

FIG. 17 illustrates a schematic view showing a chip or executing the disclosed method in a network node.

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure. In this disclosure, the term “/” should be interpreted to indicate “and/or.”

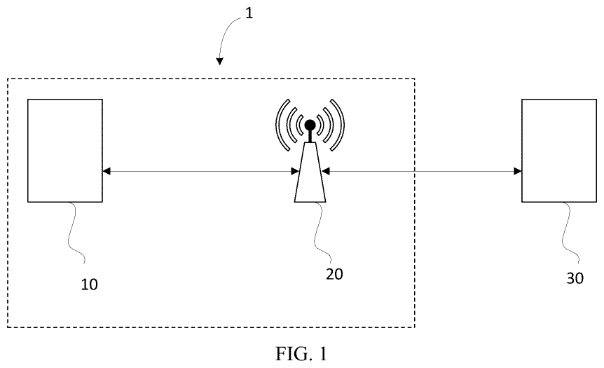

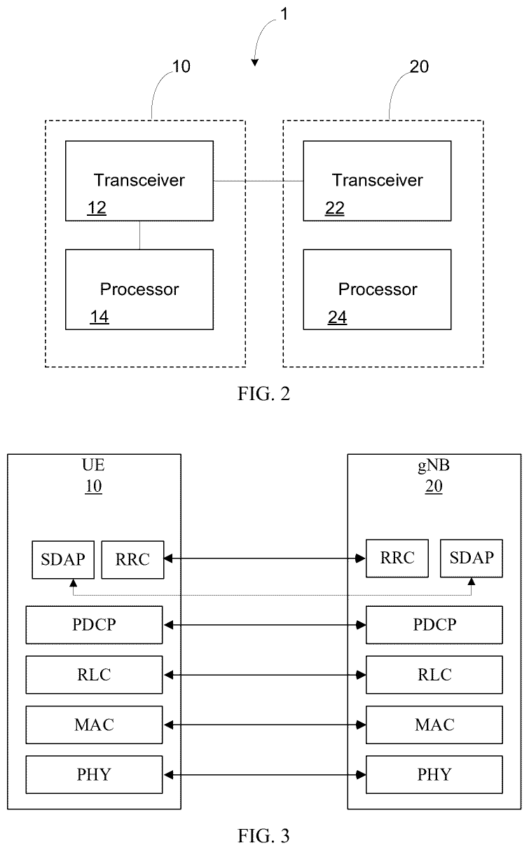

A schematic view and a functional block diagram of a communication controlling system 1 according to the present invention are shown in FIG. 1 and FIG. 2 respectively. The communication controlling system 1 comprises a user equipment 10 and a base station 20. The user equipment 10 and the base station 20 may communicate with each other either wirelessly or in a wired way. The base station 20 and a next generation core network 30 may also communicate with each other either wirelessly or in a wired way. When the communication controlling system 1 complies with the New Radio (NR) standard of the 3rd Generation Partnership Project (3GPP), the next generation core network (5GCN) 30 is a backend serving network system and may comprise an Access and Mobility Management Function (AMF), User Plane Function (UPF), and a Session Management Function (SMF). The user equipment 10 may be a NES UE, a NES-capable UE, a non-NES UE, an MBS-capable UE, and/or an SDT-capable UE, but the present disclosure is not limited to this.

The base station 20 comprises a processor 24 and at least one transceiver 22. These elements are interconnected to facilitate communication with user equipment (UE) 10. The transceiver 12 of UE 10 transmits signals to the base station, which are processed by the base station's processor 24. Conversely, the base station transmits signals using transceiver 22, which are processed by the UE's processor 14. This bidirectional exchange of signals enables communication between the UE 10 and the base station 20.

Uplink (UL) transmission of a control signal or data may be a transmission operation from a UE to a base station. Downlink (DL) transmission of a control signal or data may be a transmission operation from a base station to a UE. In the following description, unless elsewhere specified, a UE can be interpreted as an embodiment of the UE 10, and a gNB or a base station can be interpreted as an embodiment of the base station 20.

With reference to FIG. 3, in 5G NR systems, the base station (gNB) and User Equipment (UE) employ a radio protocol architecture. This architecture comprises layers like Radio Resource Control (RRC), Service Data Adaptation Protocol (SDAP), Packet Data Convergence Protocol (PDCP), Radio Link Control (RLC), and Medium Access Control (MAC).

With reference to FIG. 4, for certain RAN functional splits, the gNB can be further divided into a Centralized Unit (CU) and Distributed Units (DUs). The CU protocol stack typically includes RRC, SDAP, and PDCP layers, while the DUs handle RLC, MAC, and PHY layers. The F1 interface between CU and DUs connects the PDCP layer in the CU to the RLC layer in the DUs.

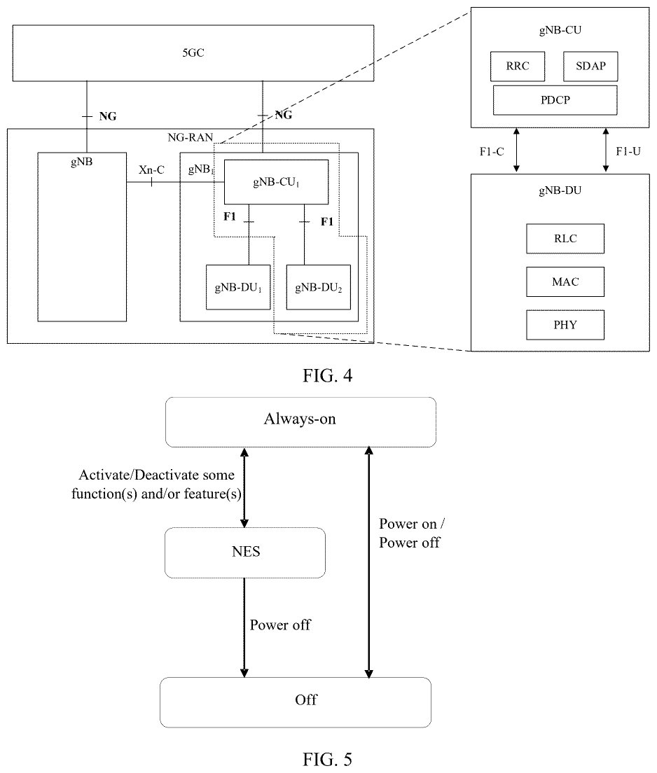

With reference to FIG. 5, an gNB state transitions in NR for Network Energy Saving (NES) involve an always-on state, a NES state, and an OFF state. Different from legacy technologies base station always-on model, a gNB (e.g., the base station 20) is either in always-on state or in NES state when the power of gNB has been turned on. In NES state, some of function components and/or radio access features can be reduced/deactivated to greatly save energy consumption of gNB. In general, a NES configuration (e.g., NES radio resource, NES barring information, NES resource transmission pattern, NES resource transmission period, Cell DTX/DRX periods, active/non-active periods, NES power level, NES spatial element, NES network identifier) is provided to the UEs. The gNB when in NES state is expected to perform signaling/data transmission and reception during the specific active periods while the downlink (DL)/uplink (UL) dynamic grant is deactivated during the non-active periods. This invention addresses the behavior of UE in monitoring periodic scheduling resources (e.g., configured grants, semi-persistent scheduling (SPS), hybrid automatic repeat request (HARQ) feedback, sounding reference signal (SRS)) during non-active periods. These resources may potentially overlap with non-active periods. The following options are considered for UE behavior in such scenarios:
1. Skipping: A UE (e.g., UE 10) assumes that such periodic scheduling resources will not be allocated so that it skips monitoring the periodic scheduling resources overlapping with non-active periods
2. A periodic scheduling configuration configurated in the NES configuration: This option leverages the NES configuration to determine which periodic scheduling resources a UE (e.g., UE 10) monitors during non-active periods. The NES configuration can include NES barring information transmitted to the UE This information might instruct the UE to continuously monitor specific configured grant (CG) resources during non-active periods while disregard Semi-Persistent Scheduling (SPS) resources during non-active periods, assuming the SPS resources will not be transmitted This approach allows for targeted monitoring based on the NES configuration, potentially reducing unnecessary monitoring overhead for the UE.
3. Keeping monitoring during non-active periods: In this option, the UE maintains the same behavior used during active periods even during non-active periods. This means the UE continuously monitors the Semi-Persistent Scheduling (SPS) resources and performs the associated signaling and data transmission/reception even when in a non-active period.

An NES cell is a cell which adopts the NES techniques in time/frequency/spatial/power domain on the specific time/frequency radio resources. The NES cell configures the NES configuration to the UEs in RRC_CONNECTED/RRC_INACTIVE/RRC_IDLE state via broadcast or unicast signaling (e.g., system information, RRCConnection, RRCReconfiguration, RRC Reject, RRCRelease, RRCResume, Paging). A Cell DTX/DRX (i.e., active and non-active periods) can be configured per serving cell. Cell DTX and Cell DRX can be configured and operated either separately or together. A UE supports NES that means the UE is capable of accessing NES cell DTX/DRX.

A NES barring information can be used to prevent non-NES UEs from camping on an NES cell while NES-capable UEs or NES UEs are permitted to camp on In addition, the NES barring information for each periodic scheduling configuration can be used for NES UEs to determine the behavior during active periods and non-active periods. The NES barring information is configured in lower layer signaling (e.g., master information block (MIB), system information block (SIB), RRC reject, RRC release, random access response (RAR), downlink control information (DCI)) and is transmitted to the UEs. Those UEs can perform radio access based on one or more categories of NES barring information which may comprise:
NES barring time: The NES barring time can be cell-specific and/or service-specific. If the NES barring time is cell-specific and set for an NES cell, the NES cell will be treated as a barring cell during the time. The NES barring time can be used to indicate a time or a period during which those non-NES UEs and NES-capable UEs received the time information are barred from the NES cell or an indicated NES service. In addition, the NES barring time can be associated with the non-active period of the NES cell (e.g., the off duration of Cell discontinuous transmission (DTX)/discontinuous reception (DRX)). If the NES barring time is service-specific to an indicated NES service, the indicated NES service is treated as a deactivated service. The NES UEs cannot transmit/receive such barred NES service during the time.
1-bit NES barring indicator: The 1-bit NES barring indicator is cell-specific. Setting the NES barring indicator as “on” in RRC signaling can instruct that the non-NES UEs are barred for the NES cell whereas the NES-capable UE are permitted to camp on the cell. In some cases, those UEs receive the indicator can be barred by a pre-configured NES barring time.
Multi-bit NES barring indicator: The Multi-bit NES barring indicator is service-specific or UE-specific. In service-specific cases, this indicator can constrain different NES services for access based on network/UE condition (e.g., available resources, quality of service (QoS) requirement). In UE-specific cases, this indicator can realize multiple levels of cell barring for multiple access capabilities of UEs (e.g., non-NES UE, NES-capable UE, MBS-capable UE, and/or SDT-capable UE) based on network/UE condition (e.g., cell loading, UE capability, access type). For example, when the cell loading is light (i.e., cell loading lower than a threshold), the Multi-bit NES barring indicator can be set to restrict most attempts from UEs except for NES-capable MBS-capable UEs. The NES cell only provides MBS traffic during the active periods and non-active periods. Furthermore, the concept of NES barring can be extended to include a barring duration. This duration specifies a time period during which the non-NES MBS-capable UEs are barred. In this case, the NES barring time can be associated with the non-active period of the NES cell and MBS transmission period.
Excluded NES Cell List: The list can be provided from the network (e.g., a gNB or a CN) to UEs to prevent the UEs from selecting/reselecting to the intra/inter-frequency neighboring NES cells due to some reasons (e.g., UE mobility). In other words, the NES UEs can select/reselect the cell in the excluded NES cell list for NES service based on the QoS requirement. In some cases, the non-NES UEs should not reselect a new cell within the excluded NES cell list which is received from a serving cell 20-1 or pre-configured by the network/device in advance. The serving cell 20-1 may transmit the excluded NES cell list in the RRC signaling (e.g., system information, RRC reconfiguration, RRC release) to the UEs for the sake of cell reselection.
NES flag: The flag can indicate a cell that decides to go into the NES state due to some reasons (e.g., low traffic load, offloading). This flag instructs the UE to perform either conditional handover (CHO), Radio Access Network based Notification Area Update (RANU), or cell switch More specifically, the non-NES UE should execute either CHO or cell switch once it receives the activated NES flag. In consideration of the activated NES flag and NES configuration, the NES-capable UE or NES UE within the cell can determine whether it should stay in the same cell or not.

In multi-carrier scenario, the anchor cell is a cell where a UE (e.g., UE 10) can receive essential signals, such as synchronization signal block (SSB), system information, paging, and the above NES barring information. For the sake of network energy saving, the non-anchor NES cell is a cell where a UE (e.g., UE 10) can receive none of the aforementioned essential signals, such as SSB, system information, paging, and the NES barring information. It is beneficial for a UE (e.g., UE 10) to camp on an anchor cell, not on a non-anchor NES cell. In case when random access is performed by a NES UE after cell camping, the anchor NES cell may switch the NES UE to a non-anchor NES cell for load balance among cells. Upon UE mobility, the source NES anchor cell may provide a candidate NES cell list (e.g., extract from the Excluded NES Cell List) to the NES UE for cell reselection. Whenever cell change is triggered by a target cell upon the mobility of UE (e.g., UE 10), the NES barring information of target cell can facilitate the NES UE to determine whether it should camp on or not. The NES UE can camp on a NES cell if it can tolerate the probably delayed service while the non-NES UE can avoid selecting a NES cell if another cell is available. Tolerance in this context refers to the ability of the UE to maintain acceptable performance in terms of periodicity, latency, or Quality of Service (QoS) under the updated NES service conditions. For carrier aggregation scenario, PCell handles the similar operations as those described in the aforesaid anchor cell and hence are not repeated. And the operations of NES SCell are similar as those described in the aforesaid non-anchor NES cell and hence are not repeated.

To avoid impacts on RRC_INACTIVE/RRC_IDLE UEs, a NES cell should maintain at least the necessary operations (e.g., system information, RACH, paging) for RRC_INACTIVE/RRC_IDLE UEs during the non-active periods of NES cell. Each NES cell is expected to deactivate at least some of time-sensitive service (e.g., dynamic grant, Ultra-reliable low-latency communication (URLLC) service) during the non-active periods. In other words, the NES cell is expected to perform at least periodic data and signaling transmission/reception (e.g., configured grant, SPS, HARQ feedback, SRS) without impact to the UEs within coverage of the NES cell. Those specific services (e.g., multicast and broadcast service (MBS), small data transmission (SDT)) may be supported during the NES state based on the network condition and service requirement. Some random-access channel (RACH) enhancements (e.g., reducing RACH occasions (ROs), NES preamble grouping, switching cell) associated with active/non-active periods of NES cell, and states of UEs can be used to facilitate network energy saving. More specifically, a UE (e.g., UE 10) can be configured to perform transmission or reception on a reduced number of the RACH occasions in non-active period. The reduced number of RACH occasions is associated with the periodicity of non-active period. Only the specific preamble group can be used in the NES state. In some cases, the number of preamble groups that used for different state of UEs (e.g., RRC_CONNECTED/RRC_INACTIVE/RRC_IDLE UEs) can be used to differentiate NES services permitted for the UEs in NES state, The SDT preamble group may be reused for the NES state. If the SDT is permitted in the NES cell, the RRC_INACTIVE UE with SDT capability can perform RA-SDT or CG-SDT during the NES state. Otherwise, UL grant for RRC_INACTIVE/RRC_IDLE UEs is not expected in non-active period of NES cell. For cell load sharing, a UE (e.g., UE 10) can be configured to switch to the non-anchor NES cell after performing RACH for data transmission/reception. In some cases, MBS data is allowed to transmit/receive on the non-anchor NES cell during the non-active period of NES cell.

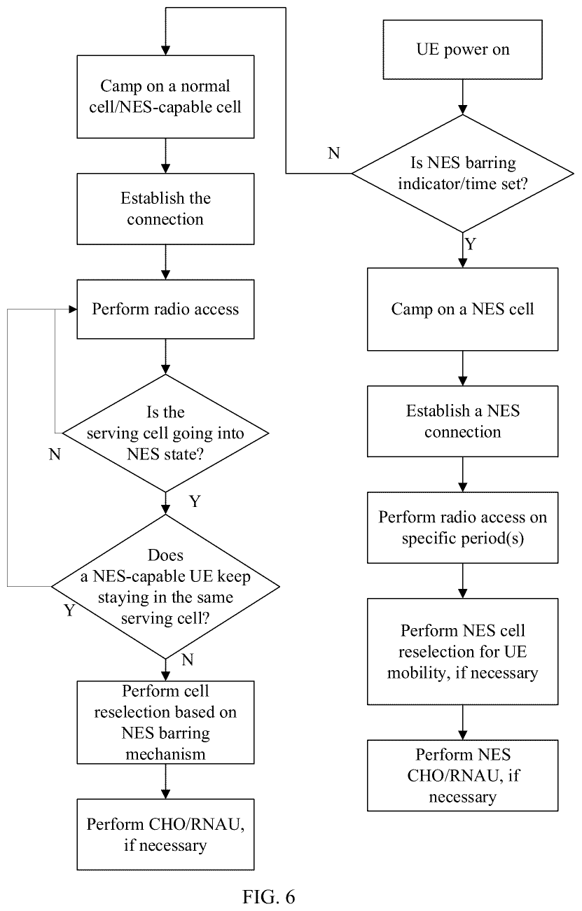

With reference to FIG. 6, from UE (e.g., UE 10) perspective, the UE behavior for communication in the NES-capable network(s) based on the aforesaid NES technique(s) The UE (e.g., UE 10) may be a NES UE, a NES-capable UE, a non-NES UE, an MBS-capable UE, and/or an SDT-capable UE, while the present disclosure is not limited to this. When a UE (e.g., UE 10) is switched on, it searches for a suitable cell based on the NES barring information. If the NES barring indicator/time is not configured/set in the received signaling (e.g., MIB, SIB), all the UEs can choose a suitable cell and then camp on that cell for the available services If the NES barring indicator/time is set but some of the NES-capable UEs are barred by the NES barring indicator/time, those un-accepted NES-capable UE should choose the other suitable cell for camping on. The initial communication is performed by the random-access procedure so that the radio access is executed on the associated radio channels. To realize network energy saving, a NES-capable cell can determine to transit from always-on state to NES state as shown in FIG. 5 due to some reasons (e.g., low traffic load, offloading). Upon the activation of NES flag, the serving NES-capable cell may trigger a cell reselection and conditional handover (CHO)/RAN-based Notification Area Update (RNAU). Then a group of UEs should switch to the neighboring cell for service continuity.

On the other hand, when the NES barring indicator/time is set for a NES cell or an anchor NES cell, only the accepted NES-capable UE can camp on the NES cell to for the available NES services. The NES-capable UE may also be an MBS-capable UE, and/or an SDT-capable UE. The NES-capable UE attaches to the network and establishes the connection with the NES cell. Upon the reception of NES configuration, data transmission and reception are generally operated on the active periods whereas some delay-tolerant services are predictable within the NES cell due to Cell DTX/DRX period. The NES-capable UE stops monitoring dynamic UL/DL grant (i.e., Physical downlink control channel (PDCCH) indicated UL/DL grant) to suspend dynamic data transmission and reception during the non-active periods. In some cases, the NES-capable UE should keep monitoring the SPS and configured grant (CG) resources on the non-active periods. The initial SPS and CO transmission/reception and the associated retransmission can be performed during the non-active periods. For example, according to the configuration of NES barring information (e.g., multi-bit NES barring indicator, NES barring time), it is expected to transmit and receive MBS/SDT during the non-active periods without impacts on MBS and SDT transmission. When the NES-capable UE detects the system information from the neighboring cell(s), it reselects a suitable target cell for service continuity based on the aforesaid NES barring information (e.g., NES barring time/indicator/excluded NES cell list) A conditional handover (CHO)/RAN-based Notification Area Update (RNAU) for NES is triggered by the UE (e.g., UE 10) or the source/target cell once one or more CHO/RNAU conditions (e.g., a NES barring indicator from the neighboring cell is detected, a signal strength is below a CHO threshold, UE capability supporting NES CHO) are met.

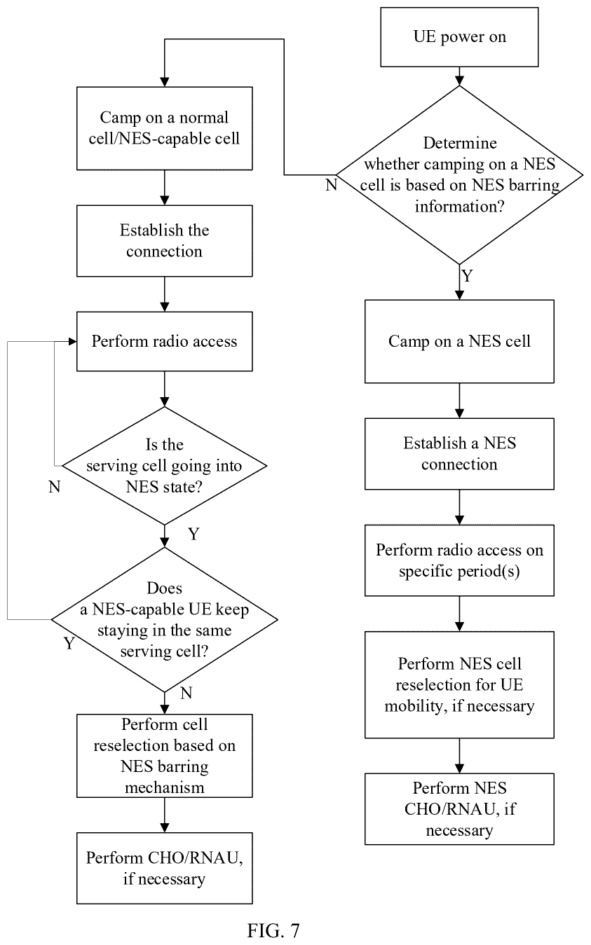

With reference to FIG. 7, another example of UE behavior is provided. A UE (e.g., UE 10) can perform UE operations in FIG. 7. The UE (e.g., UE 10) may be a NES UE, a NES-capable UE, a non-NES UE, an MBS-capable UE, and/or an SDT-capable UE, while the present disclosure is not limited to this. The UE determines whether camping on a NES cell is based on NES barring information. When camping on a NES cell is based on NES barring information, the UE searches for and camps on an NES cell. When camping on a NES cell is not based on NES barring information, the UE searches for and camps on a normal cell or an NES-capable cell.

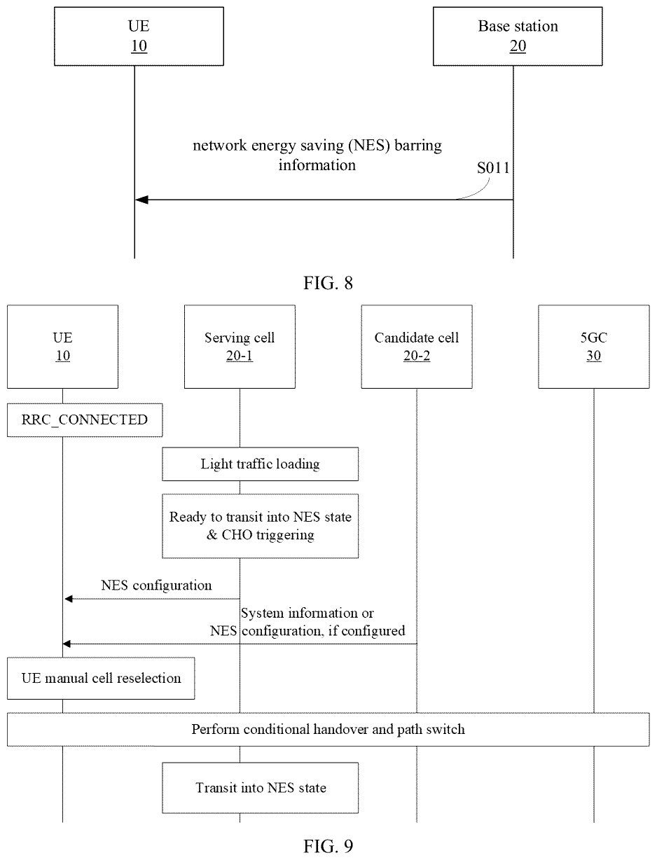

With reference to FIG. 8, the UE 10 and the gNB 20 execute an embodiment of the disclosed wireless communication method.

Step S011: The base station 20 transmits to the UE 10 a network energy saving (NES) barring information. The UE 10 receives the NES barring information from the base station 20. The UE 10 searches for and camps on a cell based on received network energy saving (NES) barring information. The NES barring information comprises at least one bit and indicates whether one or more user equipments (UEs) are permitted to camp on the NES cell. The NES barring information is used for cell selection based on UE capability.

In some embodiments of the disclosure, the UE capability indicates that a UE supports NES, multimedia broadcast/multicast service (MBS), or small data transmission (SDT).

In some embodiments of the disclosure, the one or more UEs are one or more NES-capable UEs, non-NES UEs, MBS-capable UEs, or SDT-capable UEs.

In some embodiments of the disclosure, the one or more NES-capable UEs are in RRC_CONNECTED, RRC_INACTIVE, or RRC_IDLE state.

In some embodiments of the disclosure, the NES barring information is cell-specific, service-specific, or UE-specific.

In some embodiments of the disclosure, the NES barring information is transmitted in a radio resource control (RRC) signal, a medium access control (MAC) layer signal, or a physical layer signal.

In some embodiments of the disclosure, the NES barring information is used for cell reselection and for triggering the conditional handover (CHO), radio access network (RAN)-based notification area update (RNAU), or cell switch.

In some embodiments of the disclosure, the cell reselection is based on a quality of service (QoS) requirement of the one or more UEs or cell loading.

In some embodiments of the disclosure, the NES barring information is included in a NES configuration.

In some embodiments of the disclosure, the base station 20 transmits a NES configuration to the UE 10. The UE receives the NES configuration. The NES configuration comprises at least one of: NES radio resource, NES barring information, NES resource transmission pattern, Cell DTX/DRX periods, active/non-active periods, NES power level, NES spatial element, and NES network identifier.

In some embodiments of the disclosure, the NES configuration is used for cell reselection and for triggering the CHO, RNAU, or cell switch.

In some embodiments of the disclosure, the NES configuration is conveyed in either one or both of a radio resource control (RRC) signal and system information.

In some embodiments of the disclosure, the NES barring information comprises at least one of:
NES barring time;
the NES barring indicator;
Excluded NES Cell List; or
NES flag.

In some embodiments of the disclosure, the NES barring time indicates:
a cell-specific NES barring time during which the one or more UEs are barred from the NES cell; or
a service-specific NES barring time during which the one or more UEs are barred from an indicated service.

In some embodiments of the disclosure, the NES barring time is associated with a non-active period of the NES cell.

In some embodiments of the disclosure, the NES barring time specifies a time or a period during which the one or more UEs are barred from an NES service.

In some embodiments of the disclosure, the NES barring indicator is one bit and is cell-specific; and the NES barring indicator set to a first value indicates that non-NES UEs are barred from the NES cell whereas one or more NES-capable UEs are permitted to camp on the NES cell.

In some embodiments of the disclosure, the base station restricts the one or more UEs that receive the indicator from access the NES cell or an NES service for a pre-configured NES barring time.

In some embodiments of the disclosure, the NES barring indicator is service-specific and constrains at least one NES service for access based on a network condition or UE condition.

In some embodiments of the disclosure, the NES barring indicator is UE-specific and realizes multiple levels of cell barring for multiple UE capabilities or access capabilities.

In some embodiments of the disclosure, the excluded NES cell list identifies neighboring NES cells that the one or more UEs avoid selecting or reselecting for NES service; and
the neighboring NES cells comprise intra-frequency cells, inter-frequency cells, or a combination of intra-frequency cells and inter-frequency cells.

In some embodiments of the disclosure, the NES flag indicates that the NES cell entering an NES state.

In some embodiments of the disclosure, the NES flag instructs the one or more UEs to perform a handover procedure consisting of conditional handover (CHO), Radio Access Network based Notification Area Update (RANU), or cell switch.

In some embodiments of the disclosure, the CHO or RANU is triggered by the one or more of UEs, a source cell, or a target cell based on at least one of triggering conditions.

In some embodiments of the disclosure, the triggering conditions comprise one or more of:
detection of a NES barring indicator from a neighboring cell;
signal strength falling below a conditional handover (CHO) threshold; and
UE capability supporting NES CHO.

In some embodiments of the disclosure, the CHO is based on an NES mode of a base station.

In some embodiments of the disclosure, the NES configuration and the NES flag are used for the one or more UEs to determine whether to remain connected to the NES cell.

In some embodiments of the disclosure, the UE 10 operates data transmission and reception on active periods within an NES cell according to at least one of cell discontinuous transmission (DTX) period or discontinuous reception (DRX) period.

In some embodiments of the disclosure, the base station 20 operates data transmission and reception on active periods within an NES cell according to at least one of cell discontinuous transmission (DTX) period or discontinuous reception (DRX) period.

In some embodiments of the disclosure, the base station configures the one or more UEs to perform transmission or reception on a reduced number of RACH occasions in a non-active period of the NES cell.

In some embodiments of the disclosure, a specific preamble group is used in a NES state of the NES cell to differentiate services permitted for the UEs.

In some embodiments of the disclosure, the base station configures the one or more UEs to stop monitoring dynamic grant and suspend dynamic data transmission and reception during the non-active period of the NES cell.

In some embodiments of the disclosure, the base station configures the one or more UEs to skip monitoring a periodic scheduling resource overlapping with the non-active period of the NES cell.

In some embodiments of the disclosure, the periodic scheduling resource comprises at least one of configured grant, semi-persistent scheduling (SPS), hybrid automatic repeat request (HARQ) feedback, sounding reference signal (SRS).

In some embodiments of the disclosure, the base station configures the one or more UEs to keep monitoring SPS and configured grant (CG) resources on the non-active period of the NES cell.

In some embodiments of the disclosure, the base station configures the one or more UEs to transmit and receive multimedia broadcast/multicast service (MBS) or small data transmission (SDT) during the non-active period of the NES cell.

In some embodiments of the disclosure, the base station configures the one or more UEs to monitor permitted periodic scheduling resources overlapping with non-active periods of the NES cell based on an NES configuration.

In some embodiments of the disclosure, the base station configures the one or more UEs receive none of synchronization signal block (SSB), system information, paging, and the NES barring information in a non-anchor NES cell.

In some embodiments of the disclosure, if the UE is a non-NES UE located in boundary of the NES cell that operates as a serving cell, the UE performs manual cell reselection and chooses a target non-NES cell based on a CHO configuration.

In some embodiments of the disclosure, if the NES cell operates as an anchor NES cell, the NES cell instructs the one or more UEs to switch to a non-anchor NES cell for load balance among cells.

In some embodiments of the disclosure, the NES cell maintains a set of operations for RRC INACTIVE UEs or RRC_IDLE UEs during the non-active periods of the NES cell; and
the set of operations comprise at least one of system information broadcasting, RACH operation, or paging.

In some embodiments of the disclosure, the NES cell deactivates at least one time-sensitive service during the non-active periods of the NES cell.

### Embodiment 1

With reference to FIG. 9, a first embodiment of the present disclosure is as detailed in the following. The first embodiment depicts implementation scenarios of serving cell-based triggered cell switch for the connected non-NES UE between the UE 10 and the base station 20 according to the present disclosure. A non-NES UE is configured to camp either on a non-NES cell or a NES-capable cell based on the aforesaid NES barring information while preventing unnecessary NES network access attempts. A NES-capable cell is capable of network energy saving techniques in time/frequency/spatial/power domain. When the non-NES UE is connected to a NES-capable cell, the conventional radio access in the legacy or current standards can be reused (e.g., initial UL access is trigged by random access, PDCCH, MBS reception in connected state).

The NES-capable cell may enable the NES techniques and go into NES state as a NES cell when it has light traffic load. Then the serving cell 20-1 decides to offload UEs and triggers a conditional handover preparation for NES. Some NES configurations (e.g., NES flag, NES barring indicator/time, Cell DTX/DRX periods, active/non-active periods, excluded NES cell list) and NES-related CHO configuration are configured to the UEs within the coverage of serving cell 20-1. Meanwhile, some system information or NES configuration from one or more neighboring cells can be detected by the UEs located in the boundary of serving cell 20-1 during measurements. A NES configuration (e.g., NES barring indicator, NES barring time) from at least one neighboring cell and/or a NES configuration (e.g., NES flag, Excluded NES Cell List) from the serving cell 20-1 can prevent the non-NES UE from selecting a neighboring NES cell as a target cell 20-2 for performing the conditional handover (CHO). The non-NES UE within the coverage of serving cell 20-1 may reselect a target non-NES cell based on the aforesaid NES configuration and NES barring information and hence are not repeated herein.

To enhance flexibility, the non-NES UE located in the boundary of serving cell 20-1 may perform manual cell reselection and choose an appropriate target non-NES cell (or at least a NES-capable cell when no other non-NES cell is available) from the neighboring candidate cells based on the channel quality in addition to considering NES configuration and NES barring information. In this case, a condition of CHO is the reception of at least one of NES configuration and CHO configuration triggered by the serving cell 20-1. Those UEs without NES access capability should perform CHO and path switch with the target cell 20-2 and 5G core networks (5GC) based on the pre-configured NES-related CHO configuration for service continuity In some cases, the NES configuration may be ignored by the non-NES UEs for backward compatibility (not shown). The serving cell 20-1 should transmit an RRC signaling (e.g., RRCReconfiguration, paging) with NES-related CHO configuration (e.g., MeasConfig IE, CondReconfigToAddModList IE, ExcludedNESCellList IE) to the UEs when it decides to go into NES state. The non-NES UE reselects a proper target cell 20-2 based on the NES-related CHO configuration and performs CHO when the condition of CHO is met. After completing the cell switch to the appropriate target cell 20-2 for the non-NES UEs. the serving cell 20-1 transits into NES state for saving network energy.

### Embodiment 2

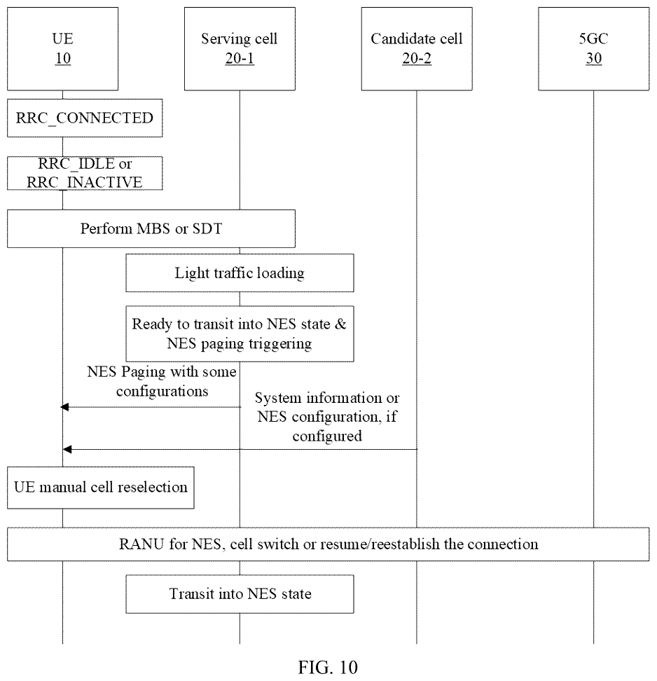

With reference to FIG. 10, a second embodiment of the present disclosure is detailed in the following. The second embodiment depicts implementation scenarios of serving cell-based triggered cell switch for the power saving non-NES UE between the UE 10 and the base station 20 according to the present disclosure A non-NES UE is configured to camp either on a non-NES cell or a NES-capable cell based on the aforesaid NES barring information while preventing unnecessary NES network access attempts. A NES-capable cell is capable of network energy saving techniques in time/frequency/spatial/power domain. The power saving UE reduces its power consumption when there is no data transmission. Some specific services (e.g., MBS, SDT) is supported in power saving state based on the network condition and service requirement. A non-NES UE with MBS-capability (referred to as non-NES MBS-capable UE) is capable of MBS reception whereas a non-NES UE with SDT capability (referred to as non-NES SDT-capable UE) is capable of SDT transmission. Both SDT-capable UE and MBS-capable UE support SDT transmission and MBS reception when the UE (e.g., UE 10) stays in power saving (e.g., RRC_IDLE, RRC_INACTIVE) state. When a power saving UE is under the coverage of a NES-capable cell, the conventional radio access in the legacy or current standards can be reused (e.g., MBS reception on MTCH or PDSCH in power saving state, RA-SDT, CG-SDT, MT-SDT). The NES-capable cell may enable the NES techniques and go into NES state as a NES cell when there is no data transmission during a long period or the number of UEs for transmitting or receiving MBS and/or SDT is small. Then the serving cell 20-1 decides to offload the UEs and triggers a NES paging for the power saving UE. Some NES configurations (e.g., NES flag, NES barring indicator/time, Cell DTX/DRX periods, active/non-active periods, excluded NES cell list), NES-related MBS configuration, and SDT configuration are configured in the NES paging signaling to the UEs within the coverage of serving cell 20-1. Meanwhile, some system information or NES configuration from one or more neighboring cells can be detected by the UEs located in the boundary of serving cell 20-1 during measurements. A NES configuration (e.g., NES barring indicator, NES barring time) from at least one neighboring cell and/or a NES configuration (e.g., NES flag, Excluded NES Cell List) from the serving cell 20-1 can prevent the non-NES UE from selecting a neighboring NES cell as a new cell after the NES paging. The non-NES UE within the coverage of serving cell 20-1 may reselect a new non-NES cell based on the aforesaid NES configuration and NES barring information and hence are not repeated herein.

To enhance flexibility, the non-NES UE located in the boundary of serving cell 20-1 may perform manual cell reselection and choose an appropriate new non-NES cell (or at least a NES-capable cell when no other non-NES cell is available) from the neighboring candidate cells based on the channel quality in addition to considering NES configuration and NES barring information. In this case, if the serving cell 20-1 decides to go into NES state, the non-NES UE in the power saving state (e.g., RRC_INACTIVE, RRC_IDLE) should perform RNAU (not shown) for NES once it detects the activated NES flag and NES configuration from serving cell 20-1. A new cell within the same RAN-based Notification Area (RNA) may be selected firstly for RNAU and the non-NES UE can keep in the power saving state without transitioning to RRC_CONNECTED state. Otherwise, the non-NES UE resumes or reestablishes the connection with the new cell when the UL access is required.

In some cases, those MBS-capable or SDT-capable UEs without NES access capability should perform cell reselection or RNAU for NES with the new cell and 5G core networks (5GC) based on the configured NES configuration, NES-related MBS configuration, and SDT configuration for service continuity. In further cases, the NES configuration may be ignored by the power saving non-NES UEs (even the MBS-capable or SDT-capable UEs) for backward compatibility (not shown). The serving cell 20-1 can transmit an RRC signaling (e.g., NES paging) with NES-related MBS configuration, and SDT configuration of neighboring cells to the UEs when it decides to go into NES state. The non-NES MBS-capable UE should reselect a proper new cell based on the NES-related MBS configuration and join the MBS session with the new cell for performing MBS reception after NES paging. The non-NES UE with SDT capability (referred to as non-NES SDT-capable UE) should resume/reestablish the connection with the new cell for performing SDT based on the NES-related SDT configuration after NES paging. For example, if the non-NES SDT-capable UE has UL SDT during the transmission of NES paging (i.e., the serving cell 20-1 is ready to transit into NES state), upon the reception of NES configuration, it may send RRCResumeRequest including at least inactive RNTI (I-RNTI) (not shown in FIG. 10) to a new cell which is in the same RNA for performing UL SDT seamlessly without transitioning to RRC_CONNECTED state. On the other hand, the non-NES UE is expected to reestablish the connection with the new cell upon the failure of connection resumption. The I-RNTI can be also used during RNAU. A RAN-based Notification Area Update (RNAU) for NES is performed whenever the power saving non-NES UE has no data transmission/reception upon the reception of NES paging. After completing the cell switch to the appropriate new cell for the power saving non-NES UEs, the serving cell 20-1 transits into NES state for saving network energy.

### Embodiment 3

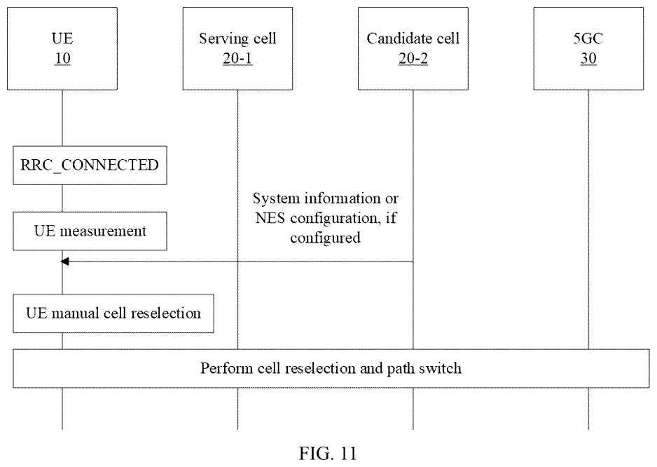

With reference to FIG. 11, a third embodiment of the present disclosure is detailed in the following. The third embodiment depicts implementation scenarios of target cell-based triggered cell switch for the non-NES UE between the UE 10 and the base station 20 according to the present disclosure. A non-NES UE is configured to camp either on a non-NES cell or a NES-capable cell based on the aforesaid NES barring information while preventing unnecessary NES network access attempts. A NES-capable cell is capable of network energy saving techniques in time/frequency/spatial/power domain, When the non-NES UE is connected to a NES-capable cell, the conventional radio access in the legacy or current standards can be reused (e.g., initial UL access is trigged by random access, PDCCH, MBS reception in connected state). Some system information or NES configuration from one or more neighboring cells can be detected by the UEs located in the boundary of serving cell 20-1 during measurements. A NES configuration (e.g., NES barring indicator, NES barring time) from at least one neighboring cell and/or a NES configuration (e.g., Excluded NES Cell List) from the serving cell 20-1 can prevent the non-NES UE from selecting a neighboring NES cell as a target cell 20-2 for performing the conditional handover (CHO) The non-NES UE moving out of the coverage of serving cell 20-1 may prioritize the candidate cells and reselect an appropriate target non-NES cell based on the aforesaid NES configuration and NES barring information and hence are not repeated herein.

To enhance flexibility, the non-NES UE moving out of the coverage of serving cell 20-1 may perform manual cell reselection and choose an appropriate target non-NES cell (or at least a NES-capable cell when no other non-NES cell is available) from the neighboring candidate cells based on the channel quality in addition to considering NES configuration and NES barring information. In this case, a condition of CHO is the reception of at least one of system information and NES configuration triggered by the target cell 20-2. Those UEs without NES access capability should perform CHO and path switch with the target cell 20-2 and 5G core networks (5GC) based on the received NES configuration for service continuity. In some cases, the NES configuration may be ignored by the non-NES UEs for backward compatibility (not shown). The target cell 20-2 cab transmit an RRC signaling (e.g., system information) with cell type differentiation (e.g., to differentiate non-NES cell, NES-capable cell, NES cell) to facilitate cell reselection for non-NES UEs. The non-NES UE reselects a proper target cell 20-2 based on at least the cell type differentiation and performs CHO when the condition of CHO is met. In further cases, the non-NES UE in the power saving state (e.g., RRC_INACTIVE, RRC_IDLE) should perform RNAU (not shown) for NES once it detects a new RNA identification and NES configuration from candidate cells. A target cell 20-2 within the same RAN-based Notification Area (RNA) may be selected firstly for RNAU and the non-NES UE can keep in the power saving state without transitioning to RRC_CONNECTED state. Otherwise, the non-NES UE resumes or reestablishes the connection with the target cell 20-2 when the UL access is required. After completing the cell switch and path switch to the appropriate target cell 20-2 for the non-NES UEs, the conventional radio access can be reused with the target cell 20-2 for service continuity.

### Embodiment 4

With reference to FIG. 9, a fourth embodiment of the present disclosure is detailed in the following. The fourth embodiment depicts implementation scenarios of serving cell-based triggered cell switch for the connected NES-capable UE between the UE 10 and the base station 20 according to the present disclosure. A NES-capable UE is configured to camp either on a NES-capable cell or a NES cell based on the aforesaid NES barring information for network energy saving. A NES-capable cell is capable of network energy saving techniques in time/frequency/spatial/power domain. When the NES-capable UE is connected to a NES-capable cell, the conventional radio access in the legacy or current standards can be reused (e.g., initial UL access is trigged by random access, PDCCH, MBS reception in connected state). The NES-capable cell may enable the NES techniques and go into NES state as a NES cell when it has light traffic load. Then the serving cell 20-1 decides to offload the un-acceptable UEs and triggers a conditional handover preparation for NES. Some NES configurations (e.g., NES flag, NES barring indicator/time, Cell DTX/DRX periods, active/non-active periods, excluded NES cell list) and NES-related CHO configuration are configured to the UEs within the coverage of serving cell 20-1. Meanwhile, some system information or NES configuration from one or more neighboring cells can be detected by the UEs located in the boundary of serving cell 20-1 during measurements. A NES configuration (e.g. NES barring indicator, NES barring time) from at least one neighboring cell and/or a NES configuration (e.g., NES flag, NES barring indicator/time, Cell DTX/DRX periods, active/non-active periods, excluded NES cell list) from the serving cell 20-1 can facilitate the NES-capable UE to determine whether it should stay in the same cell or not. If the NES-capable UE can tolerate the probably delayed service during upcoming Cell DTX/DRX periods or active/non-active periods, it can stay with the same serving cell 20-1 for the available NES service. Tolerance in this context refers to the ability of the UE to maintain acceptable performance in terms of periodicity, latency, or Quality of Service (QoS) under the updated NES service conditions. If the available NES service during upcoming Cell DTX/DRX periods or active/non-active periods is not expected to meet the QoS requirement of UE applications, the UE (e.g., UE 10) can select a neighboring NES cell or NES-capable cell as a target cell 20-2 for performing the conditional handover (CHO).

The NES-capable UE within the coverage of serving cell 20-1 may reselect a target NES cell or NES-capable cell based on the aforesaid NES configuration and NES barring information and hence are not repeated herein.

To enhance flexibility, the NES-capable UE located in the boundary of serving cell 20-1 may perform manual cell reselection and choose an appropriate target NES cell (or at least a NES-capable cell when no other NES cell is available) from the neighboring candidate cells based on the channel quality in addition to considering NES configuration and NES barring information. In this case, a condition of CHO is the reception of at least one of NES configuration and CHO configuration triggered by the serving cell 20-1. Those NES-capable UEs decided to change cell should perform CHO and path switch with the target cell 20-2 and 5G core networks (5GC) based on the pre-configured NES-related CHO configuration for service continuity. After configuring the UEs that stay in the serving cell 20-1 and completing the cell change to the appropriate target cell 20-2 for the connected NES-capable UEs, the serving cell 20-1 transits into NES state for saving network energy.

### Embodiment 5

With reference to FIG. 10, a fifth embodiment of the present disclosure is detailed in the following. The fifth embodiment depicts implementation scenarios of serving cell-based triggered cell switch for the power saving NES-capable UE between the UE 10 and the base station 20 according to the present disclosure A NES-capable UE is configured to camp either on a NES-capable cell or a NES cell based on the aforesaid NES barring information for facilitating network energy saving. A NES-capable cell is capable of network energy saving techniques in time/frequency/spatial/power domain. The power saving UE reduces its power consumption when there is no data transmission Some specific services (e.g., MBS, SDT) is supported in power saving state based on the network. condition and service requirement. A NES-capable MBS-capable UE is capable of NES service and MBS reception. whereas a NES-capable and SDT-capable UE is capable of NES service and SDT transmission. Both SDT-capable UE and MBS-capable UE support SDT transmission and MBS reception when the UE (e.g., UE 10) stays in power saving (e.g., RRC_IDLE, RRC_INACTIVE) state. When a power saving UE is under the coverage of a NES-capable cell, the conventional radio access in the legacy or current standards can be reused (e.g., MBS reception on MTCH or PDSCH in power saving state, RA-SDT, CG-SDT, MT-SDT). The NES-capable cell may enable the NES techniques and go into NES state as a NES cell when there is no data transmission during a long period or the number of UEs for transmitting or receiving MBS and/or SDT is small. Then the serving cell 20-1 decides to offload the un-acceptable UEs and triggers a NES paging for the power saving UE. Some NES configurations (e.g., NES flag, NES barring indicator/time, Cell DTX/DRX periods, active/non-active periods, excluded NES cell list), NES-related MBS configuration, and SDT configuration are configured in the NES paging signaling to the UEs within the coverage of serving cell 20-1. Meanwhile, some system information or NES configuration from one or more neighboring cells can be detected by the UEs located in the boundary of serving cell 20-1 during measurements.

A NES configuration (e.g., NES barring indicator, NES barring time) from at least one neighboring cell and/or a NES configuration (e.g., NES flag, NES barring indicator/time, Cell DTX/DRX periods, active/non-active periods, excluded NES cell list) from the serving cell 20-1 can facilitate the NES-capable UE to determine whether it should stay in the same cell or not. If the NES-capable UE can tolerate the probably delayed service during upcoming Cell DTX/DRX periods or active/non-active periods, it can stay with the same serving cell 20-1 for the available NES service. Tolerance in this context refers to the ability of the UE to maintain acceptable performance in terms of periodicity, latency, or Quality of Service (QoS) under the updated NES service conditions. For example, if the NES-capable MBS-capable UE decide to stay with the same serving cell 20-1 for NES MBS service, upon the reception of NES configuration, it may monitor MBS traffic channel based on NES-related MBS configuration for MBS reception. If the NES-capable and SDT-capable UE decide to stay with the same serving cell 20-1 for NES SDT service, upon the reception of NES configuration, it may send RRCResumeRequest including at least I-RNTI (not shown in FIG. 10) to the serving cell 20-1 for performing UL SDT, if necessary. When the available NES service during upcoming Cell DTX/DRX periods or active/non-active periods is not expected to meet the QoS requirement of UE applications, the UE (e.g., UE 10) can select a neighboring NES cell or NES-capable cell as a new cell after the NES paging. The NES-capable UE within the coverage of serving cell 20-1 may reselect a new NES cell or NES-capable cell based on the aforesaid NES configuration and NES barring information and hence are not repeated herein.

To enhance flexibility, the NES-capable UE located in the boundary of serving cell 20-1 may perform manual cell reselection and choose an appropriate new NES cell (or at least a NES-capable cell when no other NES cell is available) from the neighboring candidate cells based on the channel quality in addition to considering NES configuration and NES barring information. In this case, those NES-capable UEs in the power saving state decided to change cell should perform RNAU (not shown) for NES once it detects the activated NES flag and NES configuration from serving cell 20-1. Based on the aforesaid NES configuration and NES barring information, a new cell within the same RAN-based Notification Area (RNA) may be selected firstly for RNAU and the NES-capable UE can keep in the power saving state without transitioning to RRC CONNECTED state. Otherwise, the NES-capable UE resumes or reestablishes the connection with the new cell when the UL access is required. For example, the NES-capable and SDT-capable UE may send RRCResumeRequest including at least I-RNTI to a new cell which is in the same RNA for performing UL SDT seamlessly without transitioning to RRC_CONNECTED state. The NES-capable UE is expected to reestablish the connection with the new cell upon the failure of connection resumption. A RAN-based Notification Area Update (RNAU) for NES is performed whenever the power saving NES-capable UE bas no data transmission/reception upon the reception of NES paging. After configuring the UEs that stay in the serving cell 20-1 and completing the cell change to the appropriate target cell 20-2 for the power saving NES-capable UEs, the serving cell 20-1 transits into NES state for saving network energy.

### Embodiment 6

With reference to FIG. 11, a sixth embodiment of the present disclosure is detailed in the following. The sixth embodiment depicts implementation scenarios of target cell-based triggered cell switch for the NES-capable UE between the UE 10 and the base station 20 according to the present disclosure. A NES-capable UE is configured to camp either on a NES-capable cell or a NES cell based on the aforesaid NES barring information for facilitating network energy saving. A NES-capable cell is capable of network energy saving techniques in time/frequency/spatial/power domain. When the NES-capable UE is connected to a NES-capable cell, the conventional radio access in the legacy or current standards can be reused (e.g., initial UL access is trigged by random access, PDCCH, MBS reception in connected state). Some system information or NES configuration from one or more neighboring cells can be detected by the UEs located in the boundary of serving cell 20-1 during measurements. A NES configuration (e.g., NES barring indicator, NES barring time) from at least one neighboring cell and/or a NES configuration (e.g., excluded NES cell list) from the serving cell 20-1 can facilitate the NES-capable UE to select a selecting a neighboring NES cell or NES-capable cell as a target cell 20-2 for performing the conditional handover (CHO). The NES-capable UE moving out of the coverage of serving cell 20-1 may prioritize the candidate cells and reselect an appropriate target cell 20-2 based on the aforesaid NES configuration and NES barring information and hence are not repeated herein.

To enhance flexibility, the NES-capable UE moving out of the coverage of serving cell 20-1 may perform manual cell reselection and choose an appropriate target NES-capable cell (or a NES cell when no other NES-capable cell is available) from the neighboring candidate cells based on the channel quality in addition to considering NES configuration and NES barring information In this case, a condition of CHO is the reception of at least one of system information and NES configuration triggered by the target cell 20-2. Those UEs should perform CHO and path switch with the target cell 20-2 and 5G core networks (5GC) based on the received NES configuration for service continuity. In further cases, the NES-capable UE in the power saving state (e.g., RRC_INACTIVE, RRC_IDLE) should perform RNAU (not shown) for NES once it detects a new RNA identification and NES configuration from candidate cells. A target cell 20-2 within the same RAN-based Notification Area (RNA) may be selected firstly for RNAU and the NES-capable UE can keep in the power saving state without transitioning to RRC_CONNECTED state. Otherwise, the NES-capable UE resumes or reestablishes the connection with the target cell 20-2 when the UL access is required. After completing the cell switch and path switch to the appropriate target cell 20-2 for the NES-capable UEs, the conventional radio access can be reused with the target cell 20-2 for service continuity.

### Embodiment 7

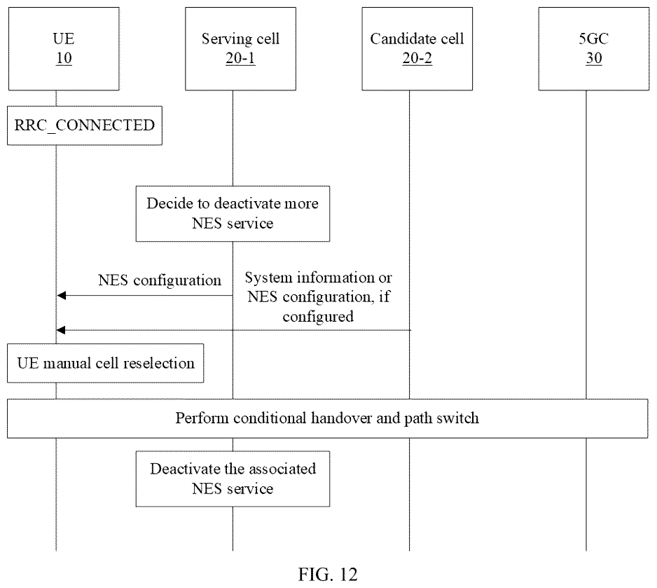

With reference to FIG. 12, a seventh embodiment of the present disclosure is detailed in the following. The seventh embodiment depicts implementation scenarios of serving cell-based triggered cell switch for the connected NES UE between the UE 10 and the base station 20 according to the present disclosure. A. NES UE is configured to camp on a NES cell based on the aforesaid NES barring information for network energy saving A NES cell provides NES service by adopting the NES time/frequency/spatial/power domain techniques on the specific time/frequency radio resources. In general the NES cell is expected to perform signaling/data transmission and reception during the active periods while the DL/UL dynamic grant is not supported during the non-active periods. Some periodic scheduling resources (e.g., configured grant, SPS, HARQ feedback, SRS, MBS) are expected to be configured in NES cell. Each periodic scheduling configuration is configurated in the NES configuration via broadcast or unicast signaling (e.g., system information, RRC connection, RRC reconfiguration, RRC reject, RRC release, RRC resume, paging) for the NES UEs. Whenever the serving NES cell decides to deactivate more NES services for limiting more UE access, it should configure the NES barring indicator/time for the associated NES service and update the NES configuration for the UEs. The connected NES UE should determine whether it can tolerate the updated NES service or not based on the updated NES configuration and QoS requirement. Tolerance in this context refers to the ability of the UE to maintain acceptable performance in terms of periodicity, latency, or Quality of Service (QoS) under the updated NES service conditions. The serving NES cell can also trigger a conditional handover preparation for the updated NES service. Some NES configurations (e.g., NES flag, NES barring indicator/time for each NES service, Cell DTX/DRX periods, active/non-active periods, excluded NES cell list) and NES-related CHO configuration are configured to the UEs within the coverage of serving cell 20-1. Meanwhile, some system information or NES configuration from one or more neighboring cells can be detected by the UEs located in the boundary of serving cell 20-1 during measurements. A NES configuration (e.g., NES barring indicator, NES barring time) from at least one neighboring cell and/or a NES configuration (e.g., NES flag, NES barring indicator/time for each NES service, Cell DTX/DRX periods, active/non-active periods, excluded NES cell list) from the serving cell 20-1 can facilitate the NES UE to determine whether it should stay in the same cell or not. If the NES UE can tolerate the updated NES service during upcoming Cell DTX/DRX periods or active/non-active periods, it can stay with the same serving cell 20-1 for the available NES service. Tolerance in this context refers to the ability of the UE to maintain acceptable performance in terms of periodicity, latency, or Quality of Service (QoS) under the updated NES service conditions. If the available NES service is not expected to meet the QoS requirement of UE applications, the NES UE can select a neighboring NES cell as a target cell 20-2 for performing the conditional handover (CHO). The NES UE within the coverage of serving cell 20-1 may reselect a target NES cell based on the aforesaid NES configuration and NES barring information and hence are not repeated herein.

To enhance flexibility, the NES UE located in the boundary of serving cell 20-1 may perform manual cell reselection and choose an appropriate target NES cell from the neighboring candidate cells based on the channel quality in addition to considering NES configuration and NES barring information. In this case, a condition of CHO is the reception of at least one of updated NES configuration and CHO configuration triggered by the serving cell 20-1. Those NES UEs decided to change cell should perform CHO and path switch with the target NES cell and 5G core networks (5GC) based on the pre-configured NES-related CHO configuration for service continuity. After configuring the UEs that stay in the serving cell 20-1 and completing the cell change to the appropriate target cell 20-2 for the connected NES UEs, the serving cell 20-1 deactivates the associated NES service(s) for saving network energy.

### Embodiment 8

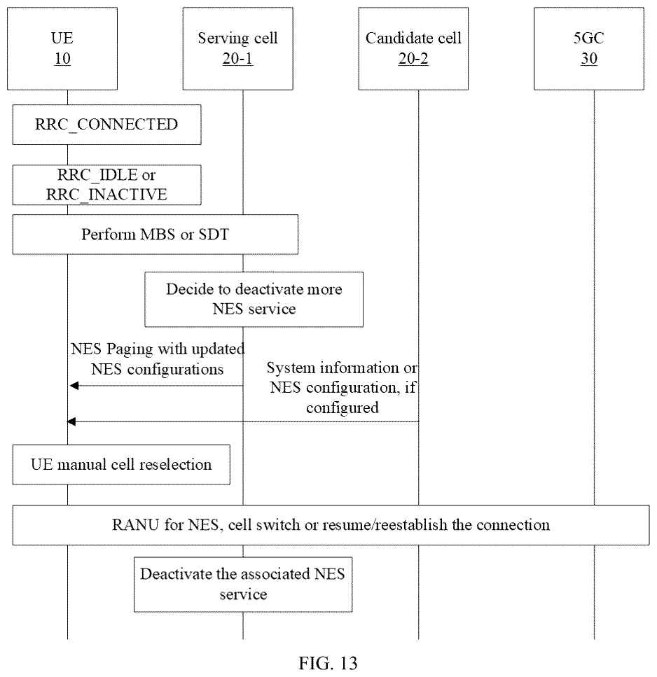

With reference to FIG. 13, an eighth embodiment of the present disclosure is detailed in the following. The eighth embodiment depicts implementation scenarios of serving cell-based triggered cell switch for the power saving NES UE between the UE 10 and the base station 20 according to the present disclosure. A NES UE is configured to camp on a NES cell based on the aforesaid NES barring information for network energy saving. The power saving NES UE reduces its power consumption when there is no data transmission. Some specific services (e.g., MBS, SDT) is supported in power saving state based on the network condition and service requirement A NES MBS-capable UE is capable of NES service and MBS reception while a NES SDT-capable UE is capable of NES service and SDT transmission. Both SDT-capable UE and MBS-capable UE support SDT transmission and MBS reception when the UE (e.g., UE 10) stays in power saving (e.g. RRC_IDLE, RRC_INACTIVE) state. A NES cell provides NES service by adopting the NES time/frequency/spatial/power domain techniques on the specific time/frequency radio resources. The available NES service is determined by the network/UE condition (e.g., cell loading, available resources, QoS requirement). Some NES services can be available (e.g., MBS reception on MTCH or PDSCH in power saving state, RA-SDT, CG-SDT, MT-SDT) for the power saving NES UEs. In general, the NES cell is expected to perform signaling/data transmission and reception during the active periods while the DL/UL dynamic grant is not supported during the non-active periods. Some periodic scheduling resources (e.g., configured grant, SPS, HARQ feedback, SRS, MBS, SDT) are expected to be configured in NES cell. Each periodic scheduling configuration is configurated in the NES configuration via broadcast or unicast signaling (e.g., system information, RRC connection, RRC reconfiguration, RRC reject, RRC release, RRC resume, paging) for the NES UEs. Whenever the serving NES cell decides to deactivate more NES services for limiting more UE access, it should configure the NES barring indicator/time for the associated NES service and update the NES configuration for the UEs. The power saving NES UE should determine whether it can tolerate the updated NES service or not based on the updated NES configuration and QoS requirement. Tolerance in this context refers to the ability of the UE to maintain acceptable performance in terms of periodicity, latency, or Quality of Service (QoS) under the updated NES service conditions. Some NES configurations (e.g., NES flag, NES barring indicator/time for each NES service, Cell DTX/DRX periods, active/non-active periods, excluded NES cell list), NES-related MBS configuration, and SDT configuration are configured in the NES paging signaling to the UEs within the coverage of serving cell 20-1. Meanwhile, some system information or NES configuration from one or more neighboring cells can be detected by the UEs located in the boundary of serving cell 20-1 during measurements.

A NES configuration (e.g., NES barring indicator, NES barring time) from at least one neighboring cell and/or a NES configuration (e.g., NES flag, NES barring indicator/time for each NES service, Cell DTX/DRX periods, active/non-active periods, excluded NES cell list) from the serving cell 20-1 can facilitate the NES UE to determine whether it should stay in the same cell or not. If the NES UE can tolerate the updated NES service during upcoming Cell DTX/DRX periods or active/non-active periods, it can stay with the same serving cell 20-1 for the available NES service. Tolerance in this context refers to the ability of the UE to maintain acceptable performance in terms of periodicity, latency, or Quality of Service (QoS) under the updated NES service conditions, For example, if the NES MBS-capable UE decide to stay with the same serving cell 20-1 for NES MBS service, upon the reception of updated NES configuration, it may monitor MBS traffic channel based on NES-related MBS configuration for MBS reception, If the NES SDT-capable UE decide to stay with the same serving cell 20-1 for NES SDT service, upon the reception of updated NES configuration, it may send RRCResumeRequest including at least I-RNTI (not shown in FIG. 13) to the serving cell 20-1 for performing UL SDT, if necessary. When the available NES service during upcoming Cell DTX/DRX periods or active/non-active periods is not expected to meet the QoS requirement of UE applications, the UE (e.g., UE 10) can select a neighboring NES cell or NES-capable cell as a new cell after the NES paging. The NES UE within the coverage of serving cell 20-1 may reselect a new NES cell based on the aforesaid NES configuration and NES barring information and hence are not repeated herein.

To enhance flexibility, the NES UE located in the boundary of serving cell 20-1 may perform manual cell reselection and choose an appropriate new cell from the neighboring candidate cells based on the channel quality in addition to considering NES configuration and NES barring information. In this case, those power saving NES UEs decided to change cell should perform RNAU (not shown) for NES once it receives the updated NES configuration from serving cell 20-1. Based on the aforesaid NES configuration and NES barring information, a new NES cell within the same RAN-based Notification Area (RNA) may be selected firstly for RNAU and the NES UE can keep in the power saving state without transitioning to RRC CONNECTED state. Otherwise, the NES UE resumes or reestablishes the connection with the new cell when the UL access is required. The NES-capable UE is expected to reestablish the connection with the new cell upon the failure of connection resumption. A RAN-based Notification Area Update (RNAU) for NES is performed whenever the power saving NES UE has no data transmission/reception upon the reception of NES paging. After configuring the UEs that stay in the serving cell 20-1 and completing the cell change to the appropriate target cell 20-2 for the power saving NES UEs, the serving cell 20-1 deactivates the associated NES service(s) for saving network energy.

### Embodiment 9

With reference to FIG. 11, a nineth embodiment of the present disclosure is detailed in the following. The nineth embodiment depicts implementation scenarios of target cell-based triggered cell switch for the NES UE between the UE 10 and the base station 20 according to the present disclosure. A NES UE is configured to camp on a NES cell based on the aforesaid NES barring information for network energy saving. A NES cell provides NES service by adopting the NES time/frequency/spatial/power domain techniques on the specific time/frequency radio resources. Some system information or NES configuration from one or more neighboring cells can be detected by the UEs located in the boundary of serving cell 20-1 during measurements. A NES configuration (e.g., NES barring indicator, NES barring time) from at least one neighboring cell and/or a NES configuration (e.g., excluded NES cell list) from the serving cell 20-1 can facilitate the NES UE to select a selecting a neighboring NES cell or NES-capable cell as a target cell 20-2 for performing the conditional handover (CHO). The NES UE moving out of the coverage of serving cell 20-1 may prioritize the candidate cells and reselect an appropriate target cell 20-2 based on the aforesaid NES configuration and NES barring information and hence are not repeated herein.

To enhance flexibility, the NES UE moving out of the coverage of serving cell 20-1 may perform manual cell reselection and choose an appropriate target cell 20-2 from the neighboring candidate cells based on the channel quality in addition to considering NES configuration and NES barring information In this case, a condition of CHO is the reception of at least one of system information and NES configuration triggered by the target cell 20-2. Those UEs should perform CHO and path switch with the target cell 20-2 and 5G core networks (5GC) based on the received NES configuration for service continuity. In further cases, the power saving NES UE should perform RNAU (not shown) for NES once it detects a new RNA identification and NES configuration from candidate cells. A target cell 20-2 within the same RAN-based Notification Area (RNA) may be selected firstly for RNAU and the NES UE can keep in the power saving state without transitioning to RRC_CONNECTED state. Otherwise, the NES UE resumes or reestablishes the connection with the target cell 20-2 when the UL access is required. After completing the cell switch and path switch to the appropriate target cell 20-2 for the NES UEs, the radio access can be maintained with the target cell 20-2 for service continuity.

### Embodiment 10

With reference to FIG. 4, a tenth embodiment of the present disclosure is detailed in the following. The tenth embodiment depicts implementation scenarios of a RAN functional split framework between the UE 10 and the base station 20 according to the present disclosure. In the aforesaid embodiments, the operations of NES barring information, NES configuration, NES paging, RANU for NES, NES-related CHO configuration MBS configuration, and SDT configuration have been described in detail in the aforesaid embodiments, and thus will not be repeated herein. With the architecture of RAN functional split as shown in FIG. 4, the associated gNB-CU/gNB-DU F1AP signaling may be used. The RRC message proposed in this embodiment is encapsulated in the FLAP signaling(s) (e.g., DL/UL RRC Message Transfer, etc.) and will not be described again.

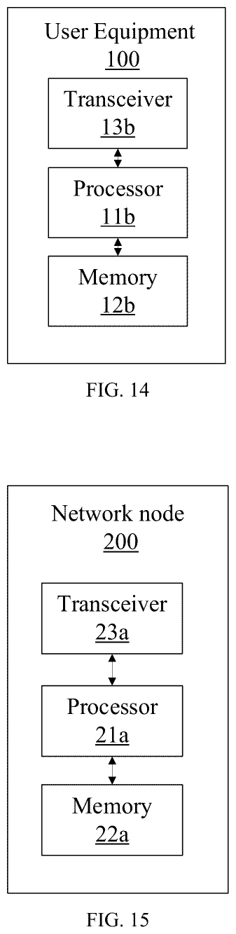

With reference to FIG. 14, the UE 100 may include a processor 11a, a memory 12a, and a transceiver 13a. The processor 11a is configured to call and run a computer program stored in the memory 12a, to cause UE 100 in which the processor 11 is installed to execute the disclosed method, steps, and/or functions of a UE. The UE 100 is an example of the UE in the description (e.g., UE 10a or UE 10b). The transceiver 13a may include baseband circuitry and radio frequency (RF) circuitry.

With reference to FIG. 15, the network node 200 is a network device and may include a processor 21a, a memory 22a, and a transceiver 23a. The processor 21a is configured to call and run a computer program stored in the memory 22a, to cause network node 200 in which the processor 11 is installed to execute the method, steps, and/or functions of a network node. The network node 200 is an example of CN network entity, network node, radio node, the base station, or gNB in the description. The transceiver 23a may include baseband circuitry and radio frequency (RF) circuitry.

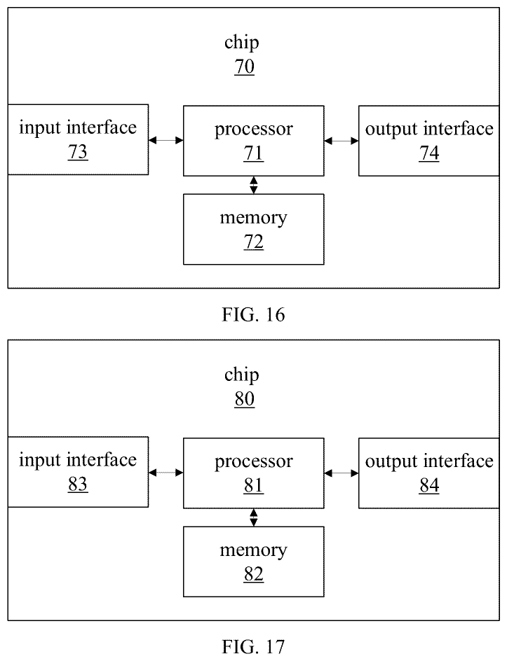

With reference to FIG. 16, the embodiment of the disclosure also provides a chip 70 that may correspond to a UE in the embodiments of the disclosure. The chip 70 may implement a corresponding process realized by the UE in various methods of the embodiments of the disclosure. The chip 70 includes a processor 71, and the processor 71 may call and run a computer program from memory to implement the methods in the embodiments of the present application.

Optionally, the chip 70 may also include a memory 72. In particular, the processor 71 may call and run the computer program from the memory 72 to implement the methods in the embodiments of the present application.

Moreover, the memory 72 may be a separate device from the processor 71 or may be integrated into the processor 71.

Optionally, the chip 70 may further include an input interface 73. Note that the processor 71 may control the input interface 73 to communicate with other devices or chips, specifically, to obtain messages or data sent by other devices or chips.

Optionally, the chip 70 may further include an output interface 74. Note that the processor 71 may control the output interface 74 to communicate with other devices or chips, specifically, to output messages or data to other devices or chips.

With reference to FIG. 17, the embodiment of the disclosure also provides another chip 80 that may correspond to a network device (e.g., CN network entity, network node, radio node, the base station, or gNB) in the description, and the chip 80 may implement the corresponding processes implemented by the network device in the various methods of the embodiments of the disclosure. The chip 80 includes a processor 81, and the processor 81 may call and run a computer program from the memory 82 to implement the methods in the embodiments of the present application.

Optionally, the chip 80 may further include a memory 82. In particular, the processor 81 may call and run the computer program from the memory 82 to implement the methods in the embodiments of the present application.

Wherein the memory 82 may be a separate device from the processor 81 or may be integrated into the processor 81.

Optionally, the chip 80 may also include an input interface 83. In particular, the processor 81 may control the input interface 83 to communicate with other devices or chips, specifically, to obtain messages or data sent by other devices or chips.

Optionally, the chip may further include an output interface 84. In particular, the processor 81 may control the output interface 84 to communicate with other devices or chips, specifically, to output messages or data to other devices or chips.

The embodiment of the present disclosure is a combination of techniques/processes that may be adopted in 3GPP specification to create an end product.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A wireless communication method for network energy saving, executable by a user equipment (UE), comprising:
receiving network energy saving (NES) barring information;
camping on a cell based on received NES barring information;
wherein the NES barring information comprises at least one bit and indicates whether one or more user equipments (UEs) are permitted to camp on an NES cell; and
the NES barring information is used for cell selection based on UE capability;
the method further comprises:
operating data transmission and reception on active periods within an NES cell according to at least one of cell discontinuous transmission (DTX) period or discontinuous reception (DRX) period.

2-6. (canceled)

7. The wireless communication method of claim 1, wherein the NES barring information is used for cell reselection and for triggering the conditional handover (CHO), radio access network (RAN)-based notification area update (RNAU), or cell switch;
wherein the cell reselection is based on a quality of service (QoS) requirement of the one or more UEs or cell loading.

8-9. (canceled)

10. The wireless communication method of claim 1, further comprising:
receiving a NES configuration, wherein the NES configuration comprises at least one of:
NES radio resource, NES barring information, NES resource transmission pattern, NES power level, NES spatial element, and NES network identifier;
wherein the NES configuration is used for cell reselection and for triggering the CHO, RNAU, or cell switch.

11-12. (canceled)

13. The wireless communication method of claim 1, wherein the NES barring information comprises at least one of:
NES barring time;
the NES barring indicator;
Excluded NES Cell List; or
NES flag.

14. The wireless communication method of claim 13, wherein the NES barring time indicates:
a cell-specific NES barring time during which the one or more UEs are barred from the NES cell; or
a service-specific NES barring time during which the one or more UEs are barred from an indicated service;
wherein the NES barring time is associated with a non-active period of the NES cell.

15-16. (canceled)

17. The wireless communication method of claim 13, wherein the NES barring indicator is one bit and is cell-specific; and
the NES barring indicator set to a first value indicates that non-NES UEs are barred from the NES cell whereas one or more NES-capable UEs are permitted to camp on the NES cell.

18. The wireless communication method of claim 13, wherein the one or more UEs that receive the indicator are restricted from access the NES cell or an NES service for a pre-configured NES barring time.

19. (canceled)

20. The wireless communication method of claim 13, wherein the NES barring indicator is UE-specific and realizes multiple levels of cell barring for multiple UE capabilities or access capabilities.

21. The wireless communication method of claim 13, wherein the excluded NES cell list identifies neighboring NES cells that the one or more UEs avoid selecting or reselecting for NES service; and
the neighboring NES cells comprise intra-frequency cells, inter-frequency cells, or a combination of intra-frequency cells and inter-frequency cells.

22. (canceled)

23. The wireless communication method of claim 13, wherein the NES flag instructs the one or more UEs to perform a handover procedure consisting of conditional handover (CHO), Radio Access Network based Notification Area Update (RNAU), or cell switch.

24. The wireless communication method of claim 23, wherein the CHO or RNAU is triggered by the one or more of UEs, a source cell, or a target cell based on at least one of triggering conditions;
wherein the triggering conditions comprise one or more of:
detection of a NES barring indicator from a neighboring cell;
signal strength falling below a conditional handover (CHO) threshold; and
UE capability supporting NES CHO.

25-30. (canceled)

31. The wireless communication method of claim 1, wherein the one or more UE stops monitoring dynamic grant to suspend dynamic data transmission and reception during the non-active period of the NES cell.

32. The wireless communication method of claim 1, wherein the UE skips monitoring a periodic scheduling resource overlapping with the non-active period of the NES cell; and
the periodic scheduling resource comprises at least one of configured grant, semi-persistent scheduling (SPS), hybrid automatic repeat request (HARQ) feedback, sounding reference signal (SRS).

33-36. (canceled)

37. The wireless communication method of claim 1, wherein the UE receives none of synchronization signal block (SSB), system information, paging, and the NES barring information in a non-anchor NES cell.

38. The wireless communication method of claim 1, wherein if the UE is a non-NES UE located in boundary of the NES cell that operates as a serving cell, the UE performs manual cell reselection and chooses a target non-NES cell based on a CHO configuration.

39. A user equipment (UE) comprising:
a memory;
a transceiver; and
a processor configured to execute steps of:
receiving network energy saving (NES) barring information;
camping on a cell based on received NES barring information;
wherein the NES barring information comprises at least one bit and indicates whether one or more user equipments (UEs) are permitted to camp on an NES cell; and
the NES barring information is used for cell selection based on UE capability;
the method further comprises:
operating data transmission and reception on active periods within an NES cell according to at least one of cell discontinuous transmission (DTX) period or discontinuous reception (DRX) period.

40-43. (canceled)

44. A wireless communication method for network energy saving, executable by a base station, comprising:
transmitting network energy saving (NES) barring information;
wherein the NES barring information comprises at least one bit and indicates whether one or more user equipments (UEs) are permitted to camp on an NES cell; and
the NES barring information is used for cell selection based on UE capability;
wherein the method further comprises:
operating data transmission and reception on active periods within an NES cell according to at least one of cell discontinuous transmission (DTX) period or discontinuous reception (DRX) period.

45-65. (canceled)

66. The wireless communication method of claim 44, wherein the NES barring information comprises at least one of:
NES barring time;
the NES barring indicator;
Excluded NES Cell List; or
NES flag;
wherein the NES flag instructs the one or more UEs to perform a handover procedure consisting of conditional handover (CHO), Radio Access Network based Notification Area Update (RNAU) or cell switch.

67-74. (canceled)

75. The wireless communication method of claim 44, wherein the base station configures the one or more UEs to skip monitoring a periodic scheduling resource overlapping with a non-active period of the NES cell.

76-84. (canceled)

85. A base station comprising:
a processor configured to call and run a computer program stored in a memory, to cause a device in which the processor is installed to execute the method of claim 44.

86-89. (canceled)
